(19) United States
(12) Patent Application Publication
(10) Pub. No.: US 2021/0406552 A1
(43) Pub. Date: Dec. 30, 2021

(54) METHOD AND DEVICE FOR PROVIDING CONTENTS BASED ON A ROUTE

(71) Applicant: M. LAB INC., Seoul (KR)

(72) Inventors: Euijae HONG, Seoul (KR); Moon Kyoung KIM, Gyeonggi-do (KR); Wonyong KOO, Gyeonggi-do (KR)

(73) Assignee: M. LAB INC., Seoul (KR)

(21) Appl. No.: 16/914,645

(22) Filed: Jun. 29, 2020

(30) Foreign Application Priority Data
Jun. 29, 2020 (KR) 10-2020-0079528

(51) Int. Cl. G06K 9/00; G06F 16/738; H04N 19/167; G06N 20/00; G06Q 30/06

(52) U.S. Cl. CPC G06K 9/00751; G06F 16/739; G06Q 30/0643; G06N 20/00; H04N 19/167

(57) ABSTRACT

According to an embodiment of the present disclosure, a method of recommending content based on a movement route of a user includes extracting at least one video associated with a search term from among video lists associated with a position of the user when the search term is input from the user, extracting at least one piece of content associated with the search term from the extracted at least one video, and playing back detail shot information associated with a region of interest together with content selected by the user when the user selects the region of interest within the selected content.

### CROSS-REFERENCE TO RELATED APPLICATION

This application claims the benefit of Korean Patent Application No. 10-2020-0079528, filed on Jun. 29, 2020, in the Korean Intellectual Property Office, the disclosure of which is incorporated herein in its entirety by reference.

### BACKGROUND

### 1. Field

The present disclosure relates to a method of recommending content in which user request is reflected according to a movement route of a user.

### 2. Description of Related Art

As the Internet, internet protocol television (IPTV), social networking service (SNS), and mobile long-term evolution (LTE) rapidly spread and video over the top (OTT) services such as YouTube and Netflix expand, distribution and consumption of multimedia images are rapidly increasing. It is common for a user to watch a video from the beginning to the end to check content of the video.

However, although there has been an increasing demand in recent years for a user to watch only a scene to which information wanted by the user is provided in a video, it is realistically difficult to search for the content in the video in detail because the current video search is based on a title or description.

In addition, there is an increasing request for a service that provides only content corresponding to needs or search terms of a user in a video providing surrounding information on a movement route or a position of a user.

### PRIOR ART DOCUMENTS

### Patent Documents

KR 10-1575819 B1

### SUMMARY

One embodiment of the present disclosure proposes a method of providing, to a user, content and details of the content necessary on a movement route of the user by providing content or advertisements that satisfy a user request.

Additional aspects will be set forth in part in the description which follows and, in part, will be apparent from the description, or may be learned by practice of the presented embodiments of the disclosure.

According to an aspect of the present disclosure, a method of recommending content based on a movement route of a user includes receiving a request of the user as a search term; grasping a position of the user in real time; extracting at least one video associated with the search term from among video lists associated with the position of the user; extracting at least one piece of content associated with the search term from the extracted at least one video; providing an interface for selecting content for a user to check from the at least one piece of content; providing an interface for selecting a region of interest in the content selected by the user; and playing back detail shot information associated with the region of interest together with the content selected by the user.

According to the aspect of the present disclosure, the position of user grasped in real time and the content selected by the user may be displayed on a map together.

According to the aspect of the present disclosure, the search term may have a form of a sentence.

According to the aspect of the present disclosure, the detail shot information may be displayed by overlaying with the content selected by the user.

According to the aspect of the present disclosure, the detail shot information may be displayed by overlaying with the content selected by the user in a form of a speech bubble.

According to the aspect of the present disclosure, the detail shot information may include information on a target of interest in a region of interest in the content selected by the user and includes shopping mall information for selling an object identified through machine learning.

According to the aspect of the present disclosure, each of the at least one piece of content may have time information and position information on a geographic information system (GIS), and the time information may include a starting time and an ending time of the content.

According to the aspect of the present disclosure, an information value of the content may decrease as the content approaches the ending time.

According to the aspect of the present disclosure, the content selection unit may activate an interface capable of selecting the content when conditions of the starting time and the ending time of the at least one piece of content are not arranged at an input time in which the search term is input and are not arranged with content of the search term.

According to another aspect of the present disclosure, a method of recommending content based on a movement route of a user includes grasping a position of the user in real time; receiving a user request as a search term; extracting at least one video associated with the search term from among video lists associated with the position of the user; extracting at least one piece of content associated with the search term from the extracted at least one video; providing an interface for selecting content for a user to check from the at least one piece of content; and proposing a route to the user based on the selected content.

According to the aspect of the present disclosure, the providing of the interface for selecting the content includes providing an interface for selecting a region of interest within the content selected by the user; and playing back detail shot information associated with the region of interest together with the content selected by the user.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates dividing configuration elements constituting a video into scenes and shots, according to an embodiment;

FIG. 2 is a flowchart of a method of searching for video internal information, according to an embodiment;

FIG. 3 illustrates an internal configuration diagram of a device for searching for video internal information, according to an embodiment;

FIG. 4 illustrates an example of distinguishing shots in a video;

FIG. 5 is an example of assigning tag sets to shots;

FIG. 6 is an example of grouping shots into scenes;

FIG. 7 is a flowchart of a method of searching for video internal information, according to another embodiment;

FIG. 8 illustrates an embodiment for searching for video internal information;

FIG. 9 illustrates an internal configuration diagram of a smart route generation device, according to another embodiment;

FIG. 10 illustrates an implementation example of a content selection unit of FIG. 9;

FIG. 11 illustrates an example of generating a smart route;

FIG. 12 is a flowchart of generating a smart route, according to an embodiment; and

FIG. 13 is a flowchart of a method of recommending content based on a movement route of a user according to an embodiment.

FIG. 14 is another flowchart of a method of recommending content based on a movement route of a user according to another embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Hereinafter, description will be made in detail with reference to the drawings so that those skilled in the art to which the present disclosure belongs may easily understand and reproduce.

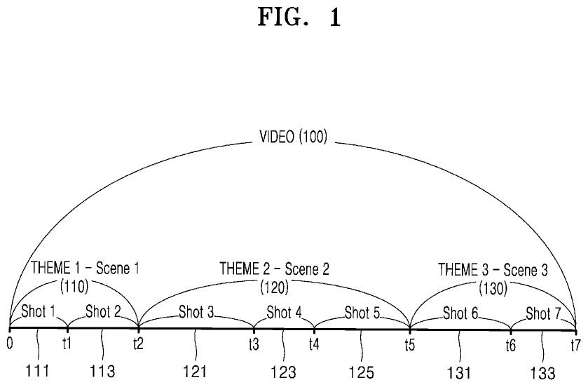

FIG. 1 illustrates dividing configuration elements constituting a video into scenes and shots, according to an embodiment.

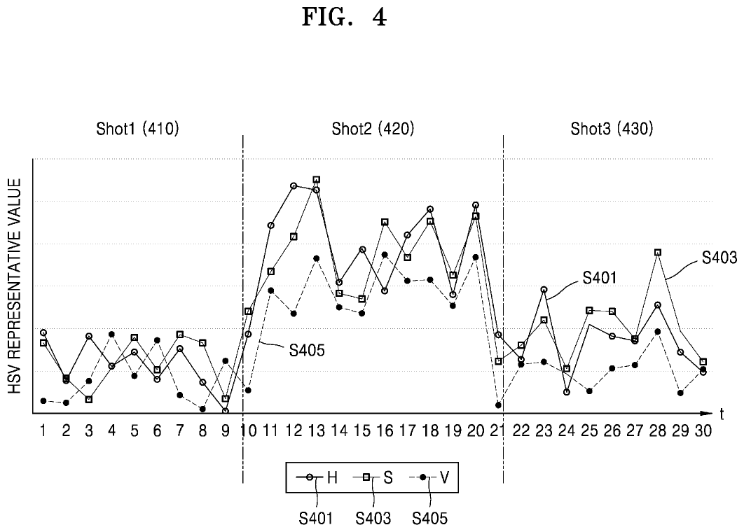

As an embodiment of the present disclosure, a video 100 is divided into n (n is a natural number) shots, for example, first to seventh shots 111, 113, 121, 123, 125, 131, and 133. A method of distinguishing shots in a video is performed with reference to content of FIG. 4.

At least one shot is grouped into units having similar meanings or themes to constitute a scene. Referring to the example of FIG. 1, the first shot 111 and the second shot 113 may be grouped into a first scene 110, the third shot 121, the fourth shot 123, and the fifth shot 125 may be grouped into a second scene 120, and the sixth shot 131 and the seventh shot 133 may be grouped into a third scene 130. In the present disclosure, a theme may include at least one meaning.

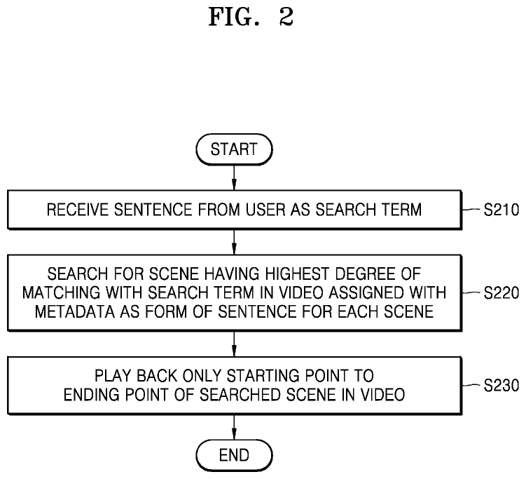

FIG. 2 is a flowchart of a method of searching for video internal information, according to an embodiment.

A user selects a video when there is content to be searched for from a specific video and inputs a search term through a search term input interface provided when video selection is activated. It is assumed that a video is indexed in units of scenes in which metadata is assigned in the form of a sentence for each scene. As an embodiment of the present disclosure, when receiving a sentence as a search term from a user, a video internal information search device searches for a specific section that matches or is highly associated with the search term in the video and plays back only the searched specific section.

As another embodiment of the present disclosure, when a user inputs a search term relevant to content to be searched for in a specific video (S210), the video internal information search device searches for a scene having the highest degree of matching with the search term in the video (S220) and plays back only a starting point to an ending point of the searched scene (S230).

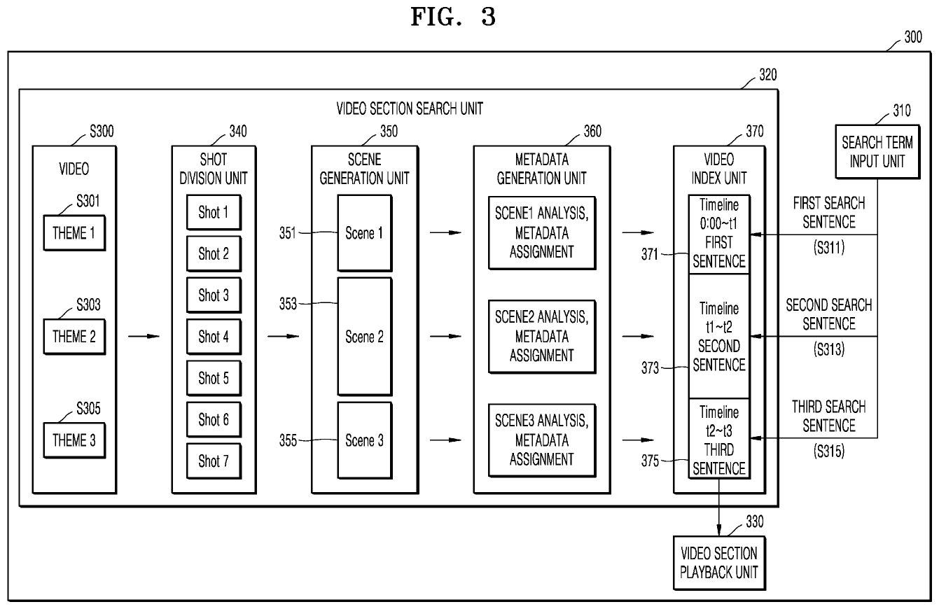

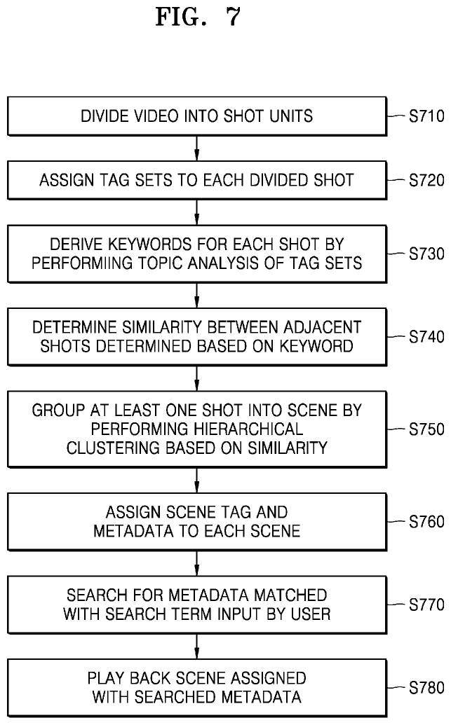

FIG. 3 illustrates an internal configuration diagram of a video internal information search device 300, according to an embodiment. FIGS. 4 to 6 illustrate detailed functions of a video section search unit 320 of the video internal information search device 300. FIG. 7 illustrates a flowchart of searching for video internal information. Hereinafter, a method of searching for video internal information using the video internal information search device is described with reference to FIGS. 3 to 7.

As an embodiment of the present disclosure, the video internal information search device 300 may be included in a terminal, a computer, a notebook computer, a handheld device, or a wearable device. In addition, the video internal information search device 300 may be implemented in the form of a terminal including an input unit for receiving a search term of a user, a display for displaying a video, and a processor. In addition, a method of searching for video internal information may be implemented by being installed in a terminal in the form of an application.

As an embodiment of the present disclosure, the video internal information search device 300 includes a search term input unit 310, the video section search unit 320, and a video section playback unit 330. The video section search unit 320 includes a shot division unit 340, a scene generation unit 350, a metadata generation unit 360, and a video index unit 370.

The search term input unit 310 receives a search term from a user in the form of a sentence. A user may use forms such as audio search, text search, and image search. In an example of the image search, content obtained by scanning a book is converted into text and used as a search term. The search term input unit 310 may be implemented with a keyboard, a stylus, a microphone, and so on.

The video section search unit 320 searches for a specific section in a video having content that matches or is associated with the search term input to the search term input unit 310. As an embodiment, the video section search unit 320 searches for a scene in which a sentence having the highest degree of matching with the received search term sentence is assigned as metadata.

The video section search unit 320 indexes and manages a video so that information may be searched for within a single video.

Referring further to FIG. 7, the shot division unit 340 divides a video into shot units (S710), assigns a tag set to each divided shot (S720), and thereafter, derives keywords for each shot by applying a topic analysis algorithm to the tag sets assigned to each shot (S730). The keywords are derived in the form of identifying and distinguishing the content of each of at least one shot constituting a video.

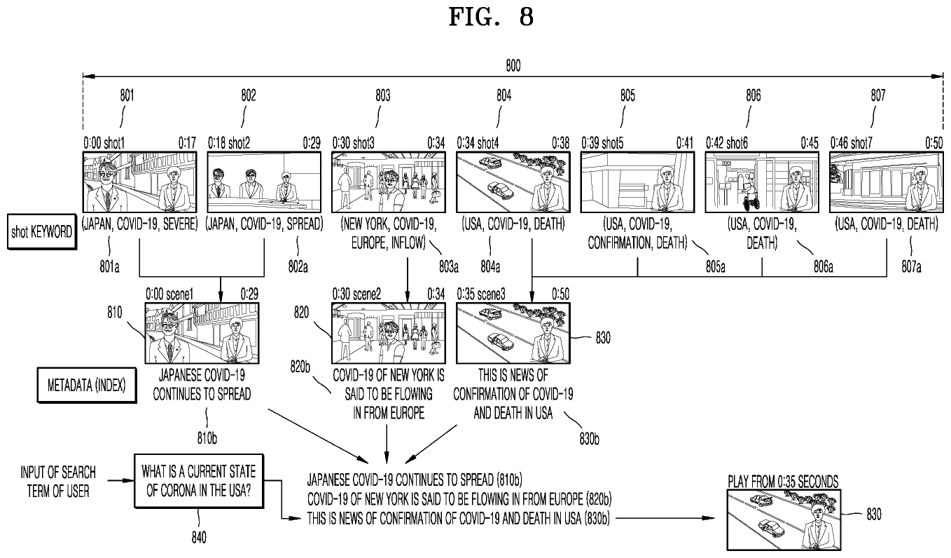

The scene generation unit 350 determines the similarity between front and rear shots adjacent to each other on a timeline of the video. The determination of similarity may be performed based on the keywords derived from each shot, objects detected from each shot, audio characteristics detected from each shot, and so on. As an embodiment of the present disclosure, the scene generation unit 350 may generate a scene by grouping shots having high similarity based on keywords between adjacent shots (S740). A grouping algorithm may include a hierarchical clustering technique (S750). In this case, a plurality of shots included in one scene may be interpreted as providing content having similar meaning or theme. FIG. 8 illustrates an example in which the scene generation unit 350 groups the shots through the hierarchical clustering.

The scene generation unit 350 assigns a scene tag to each of the generated scenes, for example, first, second, and third scenes 351, 353, and 355. The scene tag may be generated based on an image tag assigned to each of at least one shot included in each scene. In the present disclosure, a scene tag may be generated as a combination of tag sets assigned to each of at least one shot constituting the scene. In addition, a scene keyword may be generated as a combination of keywords derived from each of at least one shot constituting a scene. In one embodiment of the present disclosure, the scene tag may serve as a weighted value when generating metadata in each scene.

A metadata generation unit 360 analyzes a scene generated by the scene generation unit 350 and assigns metadata for each scene to support searching for internal content of a video (S760). The metadata assigned to each scene serves as an index. The metadata has a form of a summary sentence that displays content of each scene.

The metadata may be generated by further referring to the scene tag assigned to each of at least one shot constituting one scene. The scene tag may serve as a weighted value when performing deep learning to generate the metadata. For example, the weighted value may be assigned to image tag information and audio tag information extracted from at least one tag set included in the scene tag.

The metadata is generated based on speech to text (STT) data of audio data respectively extracted from at least one shot constituting each scene and scene tags extracted from at least one shot constituting each scene. As one example, a summary sentence is generated by performing machine learning in a deep learning manner with respect to at least one piece of STT data and at least one scene tag obtained from at least one shot constituting one scene. Metadata is assigned to each scene by using a summary sentence generated through machine learning for each scene.

A video indexing unit 370 uses the metadata assigned to each scene of a video S300 as an index. For example, when the video S300 is divided into three scenes, the video indexing unit 370 uses a first sentence 371 assigned as metadata to the first scene 351 (0:00 to t1) as an index, uses a second sentence 373 assigned as metadata to the second scene 353 (t1 to t2) as an index, and uses a third sentence 375 assigned as metadata to the third scene 355 (t2 to t3) as an index.

When it is determined that a search sentence of a user is a first search sentence S311 and the first search sentence S311 has the highest degree of matching with the first sentence 371 among a plurality of pieces of metadata 371, 373, and 375 assigned to each of a plurality of scenes in one video, the video indexing unit 370 determines that a video section having the highest degree of matching with the search sentence input to the search term input unit 310 is the first scene 351. In this case, the video section playback unit 330 plays back only 0:00 to t1, which is a section of the first scene 351 in the video S300.

As an embodiment of the present disclosure, the video indexing unit 370 may determine a degree of matching by using a Levenshtein distance technique in which a value becomes zero when two sentences are the same and the less the similarity between two sentences, the greater the value, but the present disclosure is not limited thereto, and various algorithms for determining the similarity between two sentences may be used.

Furthermore, when it is determined that the search sentence of the user is a second search sentence S313 and the second search sentence S313 has the highest degree of matching with the second sentence 373 among the plurality of pieces of metadata 371, 373, and 375 assigned to each of a plurality of scenes in one video, the video indexing unit 370 determines that a video section having the highest degree of matching with the search sentence input to the search term input unit 310 is the second scene 353. In this case, the video section playback unit 330 plays back only the sections t1 to t2 of the second scene 353 in the video S300.

Similarly, when it is determined that the search sentence of the user is the third search sentence S315 and the third search sentence S315 has the highest degree of matching with the third sentence, the video indexing unit 370 determines that a video section having the highest degree of matching with the search sentence input to the search term input unit 310 is the third scene 355. In this case, the video section playback unit 330 plays back only the sections t2 to t3 of the third scene 355 in the video S300.

FIG. 4 illustrates an example of distinguishing shots in a video. In FIG. 4, the x axis represents time (sec), and the y axis represents a hue saturation value (HSV) representative value.

As an embodiment of the present disclosure, the shot division unit 340 of a video internal information search device extracts frames as images at regular intervals from the video S300 and then converts each image into an HSV color space. Then, the shot division unit 340 generates three pieces of time-series data composed of representative values (median) of H (color) S401, S (saturation) S403, and V (brightness) S405 of each image. Then, when inflection points of each of the three pieces of time-series data of H (color) S401, S (saturation) S403, and V (brightness) S405 match each other, or are within a certain time period, the point is set as a starting point or an ending point. In FIG. 4, a point of t=10 sec at which the inflection points of each of the three pieces of time-series data match each other is set as an ending point of a first shot 410 and set as a starting point of a second shot 420. In addition, a point of t=21 sec at which the inflection points of each of the three pieces of time-series data match each other is set as an ending point of the second shot 420 and a starting point of a third shot 430.

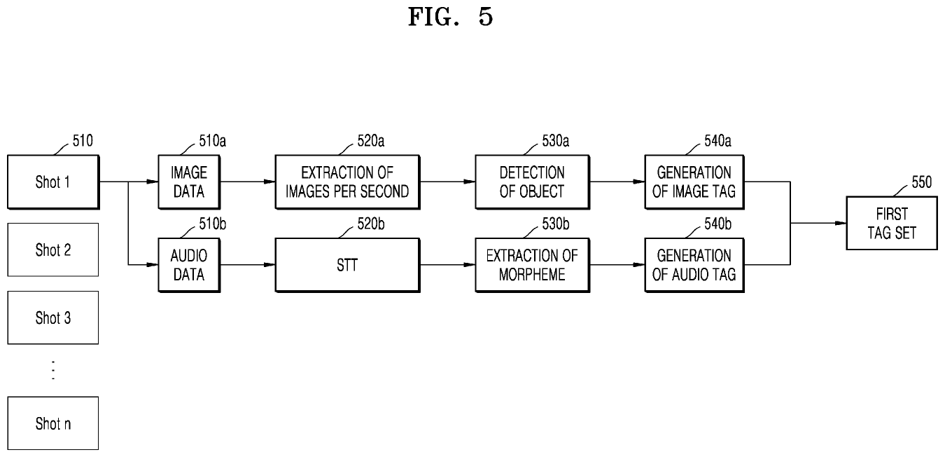

FIG. 5 is an example of assigning a tag set to a shot.

In an embodiment of the present disclosure, a tag set is assigned to each shot after a video is divided into shot units. FIG. 5 illustrates an example in which a first tag set 550 is assigned to a first shot 510.

In an embodiment of the present disclosure, the first shot 510 is divided into image data 510a and audio data 510b. Extraction of an image per second 520a from the image data 510a is performed, and then detection of an object 530a from each image is performed. Then, generation of an image tag 540a is performed based on the detected object. The image tag may be generated based on information on an object extracted from each image by applying object annotation or labeling to objects detected from an image and then performing object recognition through deep learning associated with image recognition.

In addition, the STT conversion 520b is performed for the audio data 510b, and then extraction of a morpheme 530b is performed to perform generation of an audio tag 540b. When both the image tag 540a and the audio tag 540b are generated, the tag set 550 is generated. A first tag set 550 refers to a combination of the image tag 540a and the audio tag 540b detected during the corresponding time when the first shot 510 is, for example, 00:00 to 10:00 seconds.

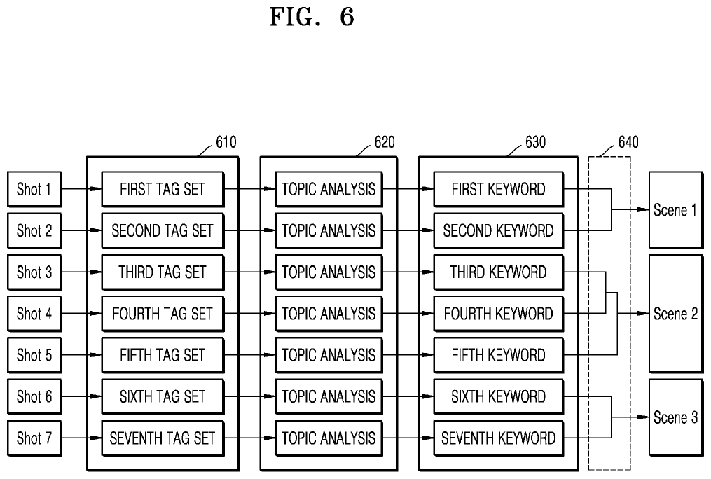

FIG. 6 is an example of grouping shots into a scene.

After an integrated tag 610 is assigned to respective shots, a topic analysis algorithm is applied to tag sets 620 assigned to respective shots to derive keywords 630 for each shot. Thereafter, the scene generation unit determines the similarity between front and rear shots adjacent to each other to group into scenes. FIG. 6 illustrates an example in which scenes are generated through hierarchical clustering 640 after similarity is determined based on the keywords 630.

FIG. 8 illustrates an embodiment of searching for video internal information.

An example is assumed in which a user selects a video 800 having an amount of 50 seconds to search for content.

The embodiment of FIG. 8 is an example in which the shot division unit divides the video 800 selected by a user into seven shots, for example, first to seventh shots 801 to 807. The video internal information search device generates a tag set by extracting an image tag and an audio tag for each of the seven shots 801 to 807, and then performs topic analysis such as LDA (Latent Dirichlet Allocation) for the tag set to derive keywords for the respective shots, that is, the first to seventh shots 801 to 807.

Referring to the embodiment of FIG. 8, the first shot 801 is a section from 0:00 to 0:17, and the first keywords derived from the first shot 801 are Japan, COVID-19, and severe 801a. The second shot 802 is a section from 0:18 to 0:29, and the second keywords derived from the second shot 802 are Japan, COVID-19, and spread 802a. The third shot 803 is a section from 0:30 to 0:34, and the third keywords derived from the third shot 803 are New York, COVID-19, Europe, and inflow 803a. The fourth shot 804 is a section from 0:34 to 0:38, and the fourth keywords derived from the fourth shot 804 are USA, COVID-19, and death 804a. The fifth shot 805 is a section from 0:39 to 0:41, and the fifth keywords derived from the fifth shot 805 are USA, COVID-19, confirmation, and death 805a. The sixth shot 806 is a section from 0:42 to 0:45, and the sixth keywords derived from the sixth shot 806 are USA, COVID19, and death 806a. The seventh shot 807 is a section from 0:46 to 0:50, and the seventh keywords derived from the seventh shot 807 are USA, COVID-19, and death 807a.

The scene generation unit groups at least one shot based on similarity. The similarity may be determined based on the keywords extracted from each shot, and image tags and audio tags may be further referred to.

In the embodiment of FIG. 8, the first shot 801 and the second shot 802 are grouped into a first scene 810, the third shot 803 is grouped into a second scene 820, and the fourth to seventh shots 804 to 807 are grouped into a third scene 830.

The first scene 810 is a section from 0:00 to 0:29 and is assigned with metadata which is “Japanese COVID-19 continues to spread.” 810b with reference to the first keywords that are Japan, COVID-19, and severe 801a derived from the first shot 801, the second keywords that are Japan, COVID-19, and spread 802a derived from the second shot 802, and audio data of the first shot 801 and the second shot 802.

The second scene 820 is a section from 0:30 to 0:34 and is assigned with metadata which is “COVID-19 of New York is said to be flowing in from Europe.” 820b with reference to the third keywords that are New York, COVID-19, Europe, and inflow 803a derived from the third shot 803 and audio data of the third shot 803.

The third scene 830 is a section from 0:35 to 0:50 and is assigned with metadata which is “this is the news of confirmation of COVID-19 and death in the USA.” 830b with reference to the fourth keywords that are USA, COVID-19, and death 804a derived from the fourth shot 804, the fifth keywords that are USA, COVID-19, confirmation, and death 805a derived from the fifth shot 805, the sixth keywords that are USA, COVID-19, and death 806a derived from the sixth shot 806, and audio data of the fourth shot 804 to the sixth shot 806.

In an embodiment of the present disclosure, a user selects the video 800, and then, when a search term input interface is activated, the user inputs content to be searched for in the form of a sentence. For example, a search term sentence “What is a current state of COVID-19 in the USA?” 840 may be input.

The video indexing unit searches for metadata having the highest degree of matching with the search term sentence 840 by using the metadata assigned to each scene as an index. The degree of matching may be determined based on the similarity between the search term sentence 840 and the metadata 810b, 820b, and 830b, and when the two sentences are the same, the degree of matching becomes 0, and as the similarity between two sentences is reduced, a Levinstein distance technique having the greater value may be used.

The video indexing unit searches for metadata which is the most similar to a search term of user 840 “what is a current state of COVID-19 in the USA?” as “it is the news of confirmation of COVID-19 and death in the USA.” 830b, and thereafter, the third scene 830 assigned with the corresponding metadata is played back to a user. When the search term sentence 840 is input, a user may search for and watch only the third scene 830 section corresponding to the section 0:35 to 0:50 relevant to the search term sentence 840 within the video 800.

As another embodiment of the present disclosure, the video indexing unit may provide a user with metadata assigned to the respective scenes 810 to 830 constituting the video as an index. A user may confirm content of the corresponding video in advance through a video index.

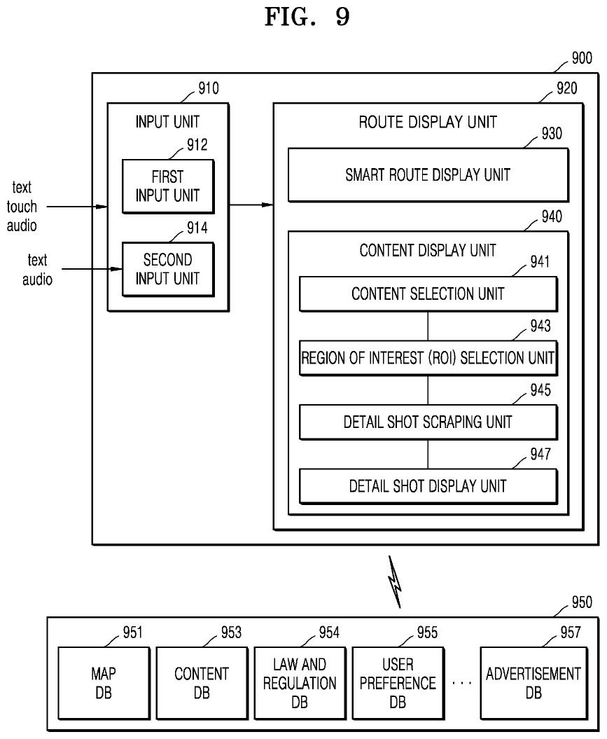

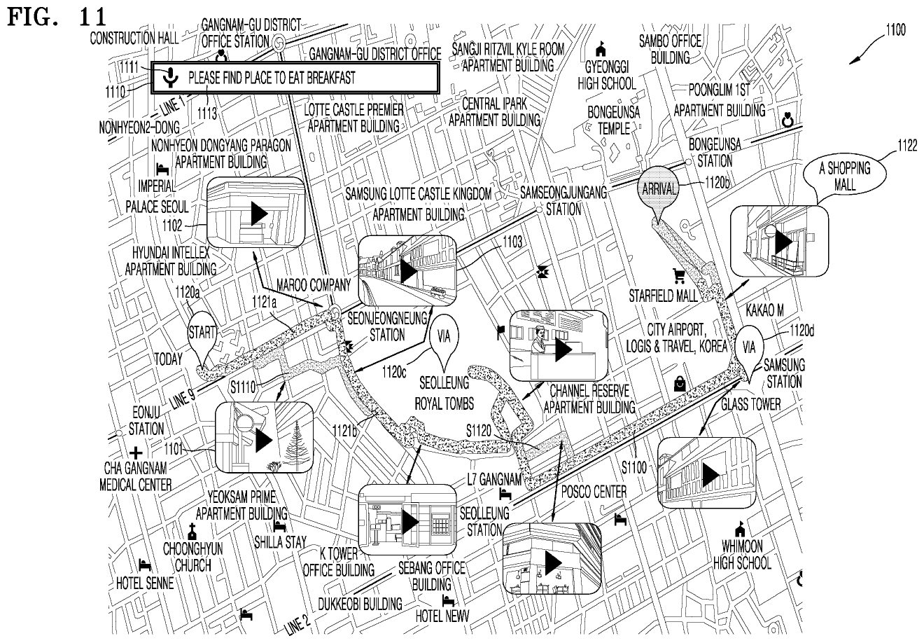

FIG. 9 illustrates an internal configuration diagram of a smart route generation device, according to another embodiment. FIG. 11 illustrates an example of a smart route presented by the smart route generation device. Description will be made with reference to FIGS. 9 and 11.

A smart route generation device 900 includes an input unit 910 and a route display unit 920 and may perform wired or wireless communication with an external server 950. For example, the external server 950 includes a server 951 including a map database, a server 953 including a content database, a law and regulation DB 944 provided with information such as a legal standard, an ethical standard, a consumer ethical standard, and an environmental standard, a server 955 that records and manages lifestyles, preferences, and so on for each user, a server 957 including an advertisement database, a communication company server, and so on.

For example, the smart route generation device 900 includes a terminal such as a cell phone, a smartphone, a smartwatch, a tablet, a notebook computer, or a PC. In addition, the smart route generation device 900 may include all forms of a terminal including a processor that controls implementation to display a route input from a user.

The input unit 910 includes a first input unit 912 and a second input unit 914. The first input unit 912 is an interface that receives a departure point and a destination from a user, and includes a text input, an audio input, a touch input, and so on. The second input unit 914 is an interface that receives a user request from a user as a search term and includes a text input and an audio input. Referring to FIG. 11, the first input unit 912 may receive a first departure point 1120a, a destination 1120b, a first stop 1120c, a second stop 1120d, and so on.

The second input unit 914 may be implemented to be activated after the first input unit 912 receives a departure point and a destination. However, it should be noted that this corresponds to one embodiment of the present disclosure and may be modified. Referring to FIG. 11, the second input unit 914 is an interface having a form of a search box 1110 and may receive an audio input 1111 to a text input 1113. As an embodiment of the present disclosure, the second input unit 914 receives a user request in the form of a sentence.

The route display unit 920 includes a smart route display unit 930 and a content display unit 940.

In an embodiment of the present disclosure, a smart route refers to a route that satisfies a user request received through the second input unit 914 among a plurality of candidate routes from a departure point to a destination input by a user.

Referring to FIG. 11, the smart route display unit 930 displays routes of a search result corresponding to the user request “please find a place to eat breakfast” 1113 among a plurality of candidate routes from a departure point 1120a to a destination 1120b. Referring to FIG. 11, the smart route display unit 930 may display a first smart route S1100, a second smart route S1110, a third smart route S1120, and so on.

The content display unit 940 displays at least one piece of content in real time on the smart route according to a user's position.

The content display unit 940 includes a content selection unit 941, a region of interest (ROI) selection unit 943, a detail shot scraping unit 945, and a detail shot display unit 947.

The content selection unit 941 supports an interface for selecting one piece of content among at least one piece of content popped up according to a user's position. An interface of the content selection unit 941 may be implemented to be activated or deactivated according to a user's setting.

The ROI selection unit 943 provides an interface for selecting a region of interest that a user wants within content selected as the highest priority among a plurality of pieces of content through machine learning according to the content selected by the user or preference of the user.

For example, a user may select a target of interest or a region of interest by moving a cursor or a mouse close to the target of interest viewed by the user in a specific shot in the content that the user watches.

When the target of interest or the region of interest in a specific shot is clicked by using the interface of the ROI selection unit 943, the detail shot scraping unit 945 automatically scrapes detailed list information on the target of interest or a target relevant to the region of interest and inserts the scraped information into a content video being played back to be displayed. To this end, the detail shot scraping unit 945 learns a target of interest or a region of interest within a specific shot through machine learning to identify the corresponding target or an object within the corresponding region.

As an embodiment, when the corresponding target is food, the detail shot scraping unit 945 scrapes a country of origin of food, raw material information, food-related legal information, and so on from the law and regulation DB 954 or a DB in which related data is previously stored.

As another embodiment, when the target of interest or an object identified within the corresponding region is cosmetic. the detail shot scraping unit 945 scrapes raw material components of cosmetics and a shopping mall site for selling cosmetics from the cosmetics DB. In addition, it is possible to further grasp whether or not there are harmful components among raw material components of the scrapped cosmetics by using the information of the law and regulation DB 954. That is, the detail shot scraping unit 945 may provide related information to a consumer by using data scraped from at least one DB.

As another embodiment, when a user is located in a restaurant of a famous entertainment agency, fixtures, food, brands, and so on in the restaurant may be provided to the user as content, and when the user selects food through the ROI selection unit 943, the detail shot scraping unit 945 scrapes information on a raw material and components of the food, a shopping mall site for selling the food, and so on. When a user selects a brand through the ROI selection unit 943, the detail shot scraping unit 945 may scrape information on the brand, information on an official website of the brand, and so on.

The detail shot display unit 947 may overlap the detail shot information scrapped by the detail shot scraping unit 945 with the content being viewed by a user or may divide a display on which the content is displayed and provide the detail shot information to one screen among the divided screens. A format of displaying the content of the detail shot information scraped by the detail shot scraping unit 945 may take the form of a speech bubble. For example, when the shopping mall information is included in the detail shot display unit in the form of a speech balloon, a user may move to the corresponding shopping mall by clicking the speech balloon.

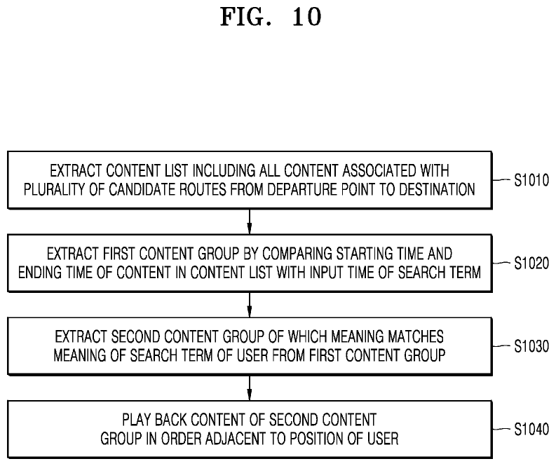

As an embodiment of the present disclosure, each piece of the content shown on the smart route has time information and location information on a geographic information system (GIS), and the time information includes a starting time and an ending time. The content selection unit selects content that satisfies a user request on a smart route by using time information and position information of each piece of the content previously stored in a preset database. Description on this will be made with reference to FIG. 10.

When a user inputs a search term through the second input unit 914, the content display unit 940 may display all content that satisfies a search term of a user on the smart route. In this case, the content may include a text, an audio, and a video and may include advertisement, SNS, blog posting, and so on.

The content display unit 940 may sequentially play back some of the content displayed on a smart route according to a real-time position of a user. In more detail, when at least one piece of content relevant to at least one smart route is a video, the content display unit 940 sequentially plays back videos in the order of content having the closest position information based on the current position of a user. A user may be provided with content relevant to a user request in real time around a movement route of the user.

For example, when a user is located at a departure point (S1120a) at time t1, and when a sandwich shop 1101 is located at the nearest place, the sandwich shop 1101 is played back. However, when the user is not on the second smart route S1110 where the sandwich shop 1101 is located at time t2 and is detected on the first smart route S1100, content of a samgyetang house 1102 closest to a position 1121a of the user detected at the time t2 is played back. Thereafter, content of a noodle house 1103 closest to a position 1121b of the user detected at time t3 is played back.

In an embodiment of the present disclosure, a video provided to the user is not all the videos included in SNS, blog posting, a video provided by an advertiser, and the like, and only a specific section relevant to a search term of the user among the videos may be provided. A method of extracting and providing only a specific section relevant to the search term of the user from a video, refer to the description made with reference to FIGS. 1 to 8.

FIG. 10 illustrates an implementation example of the content selection unit.

The content selection unit extracts a content list including all content associated with a plurality of candidate routes from a departure point to a destination that a user inputs through the first input unit 910 of FIG. 9 from a server in which content is previously stored or an external server (S1010).

Subsequently, a first content group is extracted by comparing information of a starting time and an ending time of each piece of the content in the content list with an input time of a search term of a user (1020).

For example, when a starting time of content provided by a first shop is 11:00 and an ending time thereof is 3:00, when a starting time of content provided by a second shop is 11:30 and an ending time thereof is 3:00, when a starting time of content provided by a third shop is 11:00 and an ending time thereof is 2:30, and when an input time of a search term of a user “please find a place to eat breakfast” 1113 of FIG. 11 is 11:05, only the content provided by the first shop and the content provided by the third shop are extracted as a first content group.

Next, a second content group whose meaning matches meaning of the search term of a user is extracted from the first content group (S1030). For example, when the content provided by the first shop is relevant to hair-cut and the content provided by the third shop is relevant to food, only the content provided by the third shop is extracted as the second content group. Then, the content of the second content group is played back in the order adjacent to a position of a user (S1040).

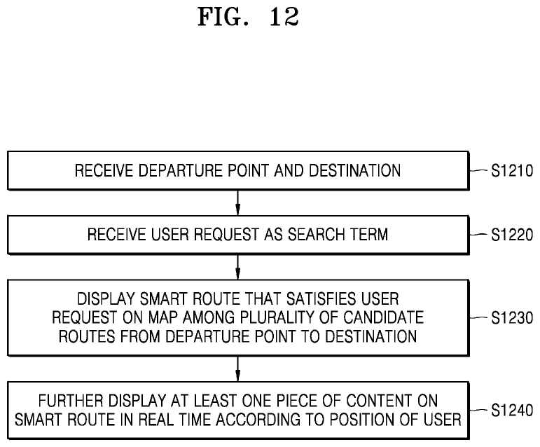

FIG. 12 is a flowchart of generating a smart route, according to an embodiment.

As an embodiment of the present disclosure, a method of generating a smart route for proposing, to a user, a destination suitable for performing a task that a user wants is as follows. A departure point and a destination are input by a user (S1210), and then a user request is input as a search term (S1220). In this case, the search term has a form of a sentence.

The smart route display unit displays a smart route that satisfies a user request on a map among a plurality of candidate routes from a departure point to a destination (S1230). In addition, at least one piece of content is further displayed on a smart route in real time according to a position of a user by the content display unit at the same time or according to selection of the user (S1240).

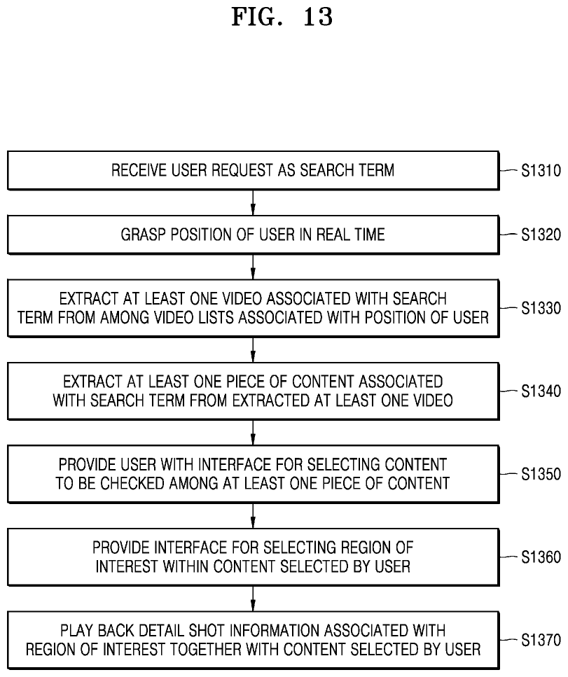

FIG. 13 is a flowchart of a method of recommending content based on a movement route of a user, according to an embodiment.

As an embodiment of the present disclosure, a terminal may grasp a position of a user in real time and receives a search term from the user (S1310 and S1320). It should be noted that the order of a step of grasping a position of a user and a step of receiving a user request as a search term in FIG. 13 may be changed.

The terminal extracts at least one video associated with a search term among video lists associated with a position of a user from at least one database. For example, when the user is located at the Seolleung Station, at least one video having position information within a preset distance from the Seolleung Station is extracted (S1330). The preset distance may be changed according to setting of a user and may be set to a time, for example, 10 minutes on foot, 5 minutes on a vehicle, 7 minutes on a bicycle, or the like. Then, among the extracted videos, an image associated with a search term of a user “please find a place to eat organic vegetarian food” is additionally extracted (S1340).

Then, at least one piece of content associated with the search term “please find a place to eat organic vegetarian food” is extracted from the extracted at least one video. For example, when five videos associated with a search term are extracted and lengths of the respective videos are 5 minutes, 7 minutes and 30 seconds, 1 hour and 10 minutes, 3 minutes, and 43 minutes, only the content corresponding to a section relevant to the search term of the user “please find a place to eat organic vegetarian food” is extracted from each video. For example, when sections associated with “please find a place to eat organic vegetarian food” in a video having a length of 1 hour and 10 minutes have a length from 3 minutes to 3 minutes and 10 seconds and a length from 10 minutes and 25 seconds to 14 minutes, two pieces of content may be presented to a user. In addition, content relevant to “please find a place to eat organic vegetarian food” may be extracted from videos respectively having lengths of 5 minutes, 7 minutes and 30 seconds, 3 minutes, and 43 minutes, and the extracted content may be presented to a user.

A user may select content to be checked from at least one piece of the presented content by using the content selection interface (S1350). The content selection unit refers to a starting time and an ending time of content. For example, a shop, which is indicated by content in which content associated with “please find a place to eat organic vegetarian food” is provided at a section of 3 minutes to 3 minutes 10 seconds, 10 minutes 25 seconds to 14 minutes, or 3 minutes to 3 minutes 10 seconds in a video having a length of 1 hour and 10 minutes, opens after 11:00 AM, and when an input time of a search term of a user is 9:00 AM, the content provided in 3 minutes to 3 minutes 10 seconds may disabled, and thus, the user may not select the content by using the content selection interface.

A user may additionally designate a region of interest or a target of interest in the content selected by the user by using an interface of the ROI selection unit (S1360). For example, while a user selects and watches content between 10 minutes 25 seconds and 14 minutes of a video having a length of 1 hour and 10 minutes associated with “please find a place to eat organic vegetarian food,” the user may designate a food menu appearing in a 13-minute shot as a target of interest. When a user designates a food menu as a target of interest, information such as a country of origin of food on the food menu, material information, an organic material or an inorganic material, a sales place, and a shopping mall (refer to 1122 of FIG. 11) may be provided to the user together with the corresponding content (S1370).

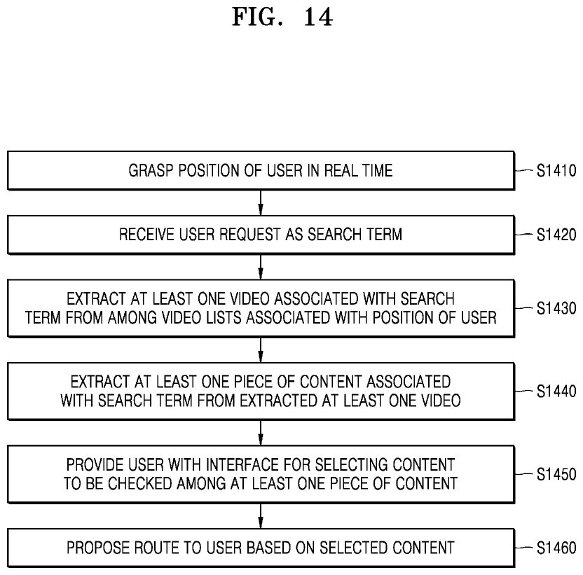

FIG. 14 is a flowchart of a method for recommending content based on a movement route of a user, according to another embodiment.

A terminal of a user grasps a position of the user in real time by using an embedded GPS sensor (S1410). Then, a user request is received as a search term (S1420). Thereafter, at least one video associated with the search term is extracted from among video lists associated with the position of the user (S1430). After extracting at least one piece of content associated with the search term from the extracted at least one video, the content selection unit provides a user with an interface for selecting content to be checked among at least one piece of content (S1440 and S1450). Thereafter, a position of a company providing the content selected by a user is displayed on a map of a terminal of a user, and a route from a current position of the user to a position of the company providing the selected content is proposed (S1460).

Methods according to the embodiments of the present disclosure may be implemented in the form of program instructions that may be executed through various computer means and may be recorded in a computer-readable medium. The computer-readable medium may include program instructions, data files, data structures, and so on alone or in combination. The program instructions recorded in the medium may be specially designed and configured for the present disclosure or may be known and usable by those skilled in computer software.

As an embodiment of the present disclosure, a method and a device of recommending content based on a route have an effect in that content of only a specific section including content that a user wants to search within a user video may be displayed on a movement route of the user within a specific route that the user seeks, and thus, the user may obtain necessary information along the movement route.

As an embodiment of the present disclosure, a method and a device of recommending content based on a route have an effect in that at least one piece of content relevant to interest of a user within a video is provided instead of the entire video, based on a movement route of the user or a position of the user.

As an embodiment of the present disclosure, a method and a device of recommending content based on a route further have an effect in that, when related content is provided based on a movement route of a user or a position of the use, a detail shot of the content may be further provided such that the user may check quality of product or service provided from the content.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

1. A method of recommending content based on a movement route of a user, the method comprising:
receiving a request of the user as a search term;
grasping a position of the user in real time;
extracting at least one video associated with the search term from among video lists associated with the position of the user;
extracting at least one piece of content associated with the search term from the extracted at least one video;
providing an interface for selecting content for a user to check from the at least one piece of content;
providing an interface for selecting a region of interest in the content selected by the user; and
playing back detail shot information associated with the region of interest together with the content selected by the user.

2. The method of recommending content based on the movement route of the user of claim 1, wherein the position of user grasped in real time and the content selected by the user are displayed on a map together.

3. The method of recommending content based on the movement route of the user of claim 1, wherein the search term has a form of a sentence.

4. The method of recommending content based on the movement route of the user of claim 1, wherein the detail shot information is displayed by overlaying with the content selected by the user.

5. The method of recommending content based on the movement route of the user of claim 4, wherein the detail shot information is displayed by overlaying with the content selected by the user in a form of a speech bubble.

6. The method of recommending content based on the movement route of the user of claim 4, wherein the detail shot information includes information on a target of interest in a region of interest in the content selected by the user and includes shopping mall information for selling an object identified through machine learning.

7. The method of recommending content based on the movement route of the user of claim 1,
wherein each of the at least one piece of content includes time information and position information on a geographic information system (GIS), and
wherein the time information includes a starting time and an ending time of the content.

8. The method of recommending content based on the movement route of the user of claim 7, wherein an information value of the content decreases as the content approaches the ending time.

9. The method of recommending content based on the movement route of the user of claim 7, wherein a content selection unit activates an interface capable of selecting the content when conditions of the starting time and the ending time of the at least one piece of content are not arranged at an input time in which the search term is input and are not arranged with content of the search term.

10. A method of recommending content based on a movement route of a user, the method comprising:
grasping a position of the user in real time;
receiving a user request as a search term;
extracting at least one video associated with the search term from among video lists associated with the position of the user;
extracting at least one piece of content associated with the search term from the extracted at least one video;
providing an interface for selecting content for a user to check from the at least one piece of content; and
proposing a route to the user based on the selected content.

11. The method of recommending content based on the movement route of the user of claim 10, wherein the providing of the interface for selecting the content comprises:
providing an interface for selecting a region of interest within the content selected by the user; and
playing back detail shot information associated with the region of interest together with the content selected by the user.

12. The method of recommending content based on the movement route of the user of claim 10, wherein the position of the user grasped in real time and the content selected by the user are displayed on a map together.

13. The method of recommending content based on the movement route of the user of claim 10, wherein the search term has a form of a sentence.

14. The method of recommending content based on the movement route of the user of claim 11, wherein the detail shot information is displayed by overlaying with the content selected by the user.

15. The method of recommending content based on the movement route of the user of claim 11, wherein the detail shot information includes information on a target of interest in a region of interest in the content selected by the user and includes shopping mall information for selling an object identified through machine learning.

16. A recording medium having recorded therein a program for executing the method of recommending content based on the movement route of the user according to claim 1.
